(19) United States
(12) Patent Application Publication
(10) Pub. No.: US 2014/0279503 A1
(43) Pub. Date: Sep. 18, 2014

(54) PROVIDING CUSTOMER ALERTS BASED ON GEO-THRESHOLDS

(71) Applicant: BANK OF AMERICA CORPORATION, Charlotte, NC (US)

(72) Inventors: Peter John Bertanzetti, Charlotte, NC (US); Laura Corinne Bondesen, Charlotte, NC (US); Matthew A. Calman, Charlotte, NC (US); David M. Grigg, Rock Hill, SC (US)

(73) Assignee: BANK OF AMERICA CORPORATION, Charlotte, NC (US)

(21) Appl. No.: 13/801,034

(22) Filed: Mar. 13, 2013

(51) Int. Cl. G06Q 20/32

(52) U.S. Cl. CPC G06Q 20/3224
USPC 705/44

(57) ABSTRACT

Embodiments of the invention provide unauthorized-transaction protection with user location verification. It is determined whether a geographic location associated with a transaction is geographically located within geo-thresholds associated with an authorized user and/or whether the geographic location associated with the transaction is geographically proximate to a geographic location associated with a mobile device that is associated with the authorized user. If neither the geographic location associated with the transaction is geographically located within the geo-thresholds nor the geographic location associated with the transaction is geographically proximate to the geographic location associated with the mobile device, an alert is sent to the authorized user and/or to a merchant associated with the transaction.

### FIELD

In general, embodiments of the invention relate to the detection and prevention of unauthorized transactions in the commercial and financial sectors, and, more particularly, methods, devices and computer program products for implementing an unauthorized-transaction protection system that incorporates user location information.

### BACKGROUND

For many individuals, the use of plastic cards such as credit and debit cards has supplanted the use of cash, checks, or other negotiable instruments as the preferred means of paying for purchases. Many financial institutions and other businesses have recognized the popularity of plastic cards among such individuals and issued numerous credit, debit, and other cards linked to credit or bank accounts that allow customers to easily, rapidly, and conveniently make purchases in person, online, and over the phone. In response, customers have grown to appreciate and expect the speed and convenience afforded by plastic cards when making purchases, and it is no longer rare for a single individual to possess many plastic cards issued by numerous banks, retailers, service providers, and other businesses.

As the population of individuals who use plastic cards has grown, so too has the likelihood of unauthorized transactions using an individual's plastic card information. Such unauthorized uses of an individual's plastic card information have widespread negative effects on the lives of individuals, and the larger economy. Beyond the damage to a customer's financial health, unauthorized transactions represent a substantial portion of the losses suffered by retailers, financial institutions, and other businesses. Accordingly, there is a need to provide methods and systems that help protect individuals and businesses from unauthorized transactions while preserving the speed and convenience associated with plastic card transactions.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. The summary's sole purpose is to present some concepts of one or more embodiments in a simplified form as a prelude to the more detailed description that is presented later.

In one aspect, the present invention embraces a system for protecting against an unauthorized transaction that includes a computing device having a memory and at least one processor and an unauthorized-transaction protection application stored in the memory and executable by the processor. The unauthorized-transaction protection application is typically configured to (i) establish geo-thresholds associated with an authorized user, (ii) receive a set of information associated with a transaction associated with the authorized user and with a merchant, wherein the set of information associated with the transaction includes an identification of a geographic location associated with the transaction, (iii) receive a set of geographic location information associated with a mobile device, wherein the mobile device is associated with the authorized user associated with the transaction, and (iv) determine whether the geographic location associated with the transaction is geographically located within the geo-thresholds and/or whether the geographic location associated with the transaction is geographically proximate to the geographic location associated with the mobile device. If neither the geographic location associated with the transaction is geographically located within the geo-thresholds nor the geographic location associated with the transaction is geographically proximate to the geographic location associated with the mobile device, the unauthorized-transaction protection application is typically configured to send an alert to the authorized user and/or to the merchant.

In another aspect, the present invention embraces a method for protecting against an unauthorized transaction. The method typically includes (i) establishing geo-thresholds associated with an authorized user, (ii) receiving a set of information associated with a transaction associated with the authorized user and with a merchant, wherein the set of information associated with the transaction includes an identification of a geographic location associated with the transaction, and (iii) receiving a set of geographic location information associated with a mobile device, wherein the mobile device is associated with the authorized user associated with the transaction. Next, it typically is determined (e.g., via a computer processor) whether the geographic location associated with the transaction is geographically located within the geo-thresholds and/or whether the geographic location associated with the transaction is geographically proximate to the geographic location associated with the mobile device. If neither the geographic location associated with the transaction is geographically located within the geo-thresholds nor the geographic location associated with the transaction is geographically proximate to the geographic location associated with the mobile device, an alert is typically sent to the authorized user and/or to the merchant.

In yet another aspect, the present invention embraces a computer program product that includes a non-transitory computer-readable storage medium. The non-transitory computer-readable storage medium typically includes codes for causing a computer processor to be configured to (i) establish geo-thresholds associated with an authorized user, (ii) receive a set of information associated with a transaction associated with the authorized user and with a merchant, wherein the set of information associated with the transaction includes an identification of a geographic location associated with the transaction, (iii) receive a set of geographic location information associated with a mobile device, wherein the mobile device is associated with the authorized user associated with the transaction, and (iv) determine whether the geographic location associated with the transaction is geographically located within the geo-thresholds and/or whether the geographic location associated with the transaction is geographically proximate to the geographic location associated with the mobile device. If neither the geographic location associated with the transaction is geographically located within the geo-thresholds nor the geographic location associated with the transaction is geographically proximate to the geographic location associated with the mobile device, the non-transitory computer-readable storage medium typically includes codes for causing the computer processor to be configured to send an alert to the authorized user and/or to the merchant

To the accomplishment of the foregoing and related ends, the one or more embodiments include the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference may now be made to the accompanying drawings.

FIG. 1 depicts a flow diagram of an exemplary method for protecting against an unauthorized transaction in accordance with an aspect of the present invention.

FIG. 2 schematically depicts an exemplary system for protecting against an unauthorized transaction in accordance with an aspect of the present invention.

FIG. 3 schematically depicts a mobile device configured for use in conjunction with embodiments of the present invention.

### DETAILED DESCRIPTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, and the like) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, or semiconductor system, apparatus, or device. More specific examples of the computer readable medium include, but are not limited to, the following: a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Computer program code for carrying out operations of embodiments of the present invention may be written in an object oriented, scripted or unscripted programming language such as Java, Perl, Smalltalk, C++, SAS or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, further details are provided below for apparatuses, methods, and computer program products representing exemplary implementations of embodiments of the present invention.

Some such embodiments contemplate an unauthorized-transaction prevention system that attempts to confirm the presence of an authorized user of an account (e.g., an account holder) at a point of sale (“POS”), point-of-transaction, or other location associated with a transaction. In implementations of such embodiments, the location of an individual's mobile device is used as an indicator of the location of that individual. In this regard, if an individual's mobile device and plastic card or other account information are simultaneously collocated at a point-of-transaction, it is highly likely that the individual making the purchase or otherwise engaging in the transaction is an authorized user of the account that is being used in the transaction. Consequently, in situations where the mobile device and credit card, debit card, or other account information are at or near the same location, the likelihood that the transaction is unauthorized is diminished.

Such embodiments also contemplate that the unauthorized-transaction prevention system attempts to confirm whether the location of the transaction is within geo-thresholds associated with the authorized user of the account. The geo-thresholds associated with the authorized user of the account typically reflects geographic locations proximate to the authorized user's home, workplace, and usual corridor of travel. It is thought that if a transaction takes place within a geographic location proximate to the authorized user's home, workplace, and usual corridor of travel, then the likelihood that the transaction is unauthorized is diminished.

Such embodiments further contemplate that the unauthorized-transaction prevention system sends an alert to the authorized user and/or to a merchant associated with the transaction if the mobile device is not collocated with transaction and if the transaction does not take place within the geo-thresholds associated with the authorized user. The alert provides notice to the authorized user and/or the merchant of possible unauthorized activity.

While many of the example implementations described herein contemplate detecting the position of a mobile device or other item associated with a user as an independent and/or initial form of authentication, it will be appreciated that the systems and methods described herein may be integrated into any approach to user authentication. For example, an implementation may examine an account holder's or authorized user's transaction history prior to determining whether a mobile device is collocated with a location associated with a transaction. In another example implementation, the position of a mobile device may be verified after another authentication sequence, such as the entry of a password or PIN number.

It will also be appreciated that the systems and methods described herein may be implemented in addition to and/or as supplements to other approaches to user authentication. For example, in some implementations, an authentication protocol may recognize an attempted transaction in a country, region, or other location that is atypical for the authorized user (e.g., account holder) and initially block or otherwise decline the transaction pending confirmation that a user's mobile device is located near the transaction. In some such example implementations, users who are travelling may avoid having legitimate transactions declined during their travels, while maintaining a degree of protection from unauthorized transactions that may occur due to lost or stolen account information.

The embodiments described herein may refer to use of a transaction or transaction event to trigger the location of the user and/or the user's mobile device. Unless specifically limited by the context, a “transaction” refers to any communication between the user and the financial institution or other entity monitoring the user's activities. In some embodiments, for example, a transaction may refer to a purchase of goods or services, a return of goods or services, a payment transaction, a credit transaction, or other interaction involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes; and the like); sending remittances; transferring balances from one account to another account; loading money onto stored value cards (SVCs) and/or prepaid cards; donating to charities; and/or the like.

FIG. 1 depicts a flow diagram of a method 100 for protecting against an unauthorized transaction in accordance one aspect of the present invention. As shown in step 110, the method typically includes establishing geo-thresholds associated with an authorized user of an account. The geo-thresholds associated with the authorized user typically include location information for geographic locations proximate to the authorized user's home, workplace, and/or usual corridor of travel. This location information may include the address, GPS coordinates, longitude and latitude, location name, and/or any other information sufficient to identify locations proximate to the authorized user's home, workplace, and/or usual corridor of travel. In some embodiments, locations proximate the authorized user's usual corridor of travel may be determined by analyzing the location history of a mobile device associated with the authorized user (e.g., by analyzing the GPS coordinates transmitted by the mobile device over a period of time). In other embodiments, locations proximate to the authorized user's usual corridor of travel may be determined by analyzing the location information associated with one or more previously approved transactions associated with the authorized user. It is thought that geographic location information history associated with the authorized user's mobile device or the authorized user's previous transactions reflect the usual corridor of travel of the authorized user. In further embodiments, the geo-thresholds associated with the authorized user may be at least partially defined by the authorized user. For example, the authorized user may provide addresses, location names, and/or GPS coordinates associated with the user's usual corridor of travel.

Typically, the geo-thresholds associated with the authorized user include one or more geo-fences that reflect geographic locations proximate to the authorized user's home, workplace, and/or usual corridor of travel. A geo-fence is a virtual perimeter that defines the boundaries of an actual geographic area. As noted above, one or more geo-fences may be based upon the location history of a mobile device associated with the authorized user and/or location information associated with one or more previously approved transactions. For example, one or more geo-fences may be associated with merchant locations where the authorized used has had one or more previously approved transactions. In a particular embodiment, one or more geo-fences associated with a merchant location may include only a portion of the merchant location. For example, a geo-fence associated with a merchant location may include the location of a merchant department (e.g., a pharmacy) in which the authorized user has had a previously approved transaction, but not include the location of another department (e.g., an automotive repair department) at the same merchant in which the authorized user has not had a previously approved transaction. In another embodiment, the geo-thresholds associated with the authorized user may include one or more geo-fences specified by the authorized user.

Step 120 includes receiving location information associated with a transaction associated with a merchant. It will be appreciated that any location information associated with a transaction may be used in example implementations of element 120. For example, the location information may include the address, GPS coordinates, longitude and latitude, location name, and/or any other information sufficient to identify a location associated with a transaction. It will also be appreciated that in implementations of step 120, the location associated with the transaction will typically be the location where an individual purporting to be an authorized user (e.g., an account holder) presents a portion of their account information. For example, in many implementations, the location associated with a transaction is a physical store or other place of business where a user presents a plastic card such as a debit or credit card. By way of example, the location information associated with the transaction may include a geo-fence associated with the location of the merchant. By way of further example, the location information associated with the transaction may include a geo-fence associated with a department location within the location of the merchant. Accordingly, transactions that occur within different merchant departments (e.g., a pharmacy department or an automotive repair department) may have different transaction location information.

However, it will be appreciated that the location could be a computer terminal or other user interface where an individual presents account information for making purchases or other transactions online. For example, the location associated with a transaction could be a home computer from which a user makes purchases, accesses account information, initiates fund transfers, or otherwise accesses account information.

It is appreciated that the transaction location information may be gathered in various manners. In one embodiment, the transaction data includes a geographic address associated with the point-of-transaction location. In other embodiments, the transaction data may include an identifier associated with the point-of-transaction merchant, which is used as a pointer to a database containing geographic location information associated with the point-of-transaction. For example, the point-of-transaction merchant may be a customer of the financial institution, in which case the financial institution maintains address information associated with the point-of-transaction merchant. When the financial transaction is received from the point-of-transaction merchant, the system may identify the point-of-transaction merchant and retrieve address information associated with the point-of-transaction merchant which can be converted to geographic location data associated with the location of the transaction. In another embodiment, the system may use name and other information associated with the point-of-transaction merchant to search public databases such as 411.com, Google, point-of-transaction merchant's website(s), and the like to determine address and/or geographic location information associated with the point-of-transaction merchant. In some embodiments, the point-of-transaction device may transmit its geographic location along with the transaction data. For example, the point-of-transaction device may be a mobile device with a GPS receiver/transmitter for transmitting geographic location information indication the location where the transaction is occurring.

As shown in step 130, the method 100 includes receiving a set of location information associated with a mobile device associated with the authorized user of the account. In this regard, the authorized user typically has one or more mobile devices associated with their account. Typically, any type of location information, including the types of location information discussed in relation to steps 110-120 may be received. For example, many mobile devices are capable of recognizing and transmitting the GPS coordinates for the position of the mobile device. In some situations, a mobile device may be capable of recognizing a wireless network provided by a store or otherwise associated with a particular location, such as an individual's home wireless network, and use that information to transmit or otherwise make available the location information associated with the mobile device. In some exemplary embodiments, the authorized user of the account may provide information about their mobile device to the financial institution or other entity that administers the account. For example, the authorized user may identify a mobile phone, a smartphone, a laptop computer, a tablet computer, and/or any of a number of mobile devices as associated with the authorized user, and allow the financial institution or other entities to receive information about the location of such mobile devices in the context of verifying transactions.

In some exemplary embodiments, accelerometer information and/or other directional information associated with the mobile device may be received. For example, accelerometer information associated with a device may indicate that the device is moving when ordinarily the device would be still during a transaction. In some example implementations, the accelerometer may indicate that a mobile device is moving away from a location associated with a transaction, which may indicate that the transaction is unauthorized. In other example implementations, a vector or other trajectory may be established based on, for example, a series of positions of the mobile device. In some such example implementations, it may be possible to establish that a mobile device is moving, such as when a user attempts to engage in a transaction during a flight, train ride, car ride, or otherwise in transit.

At step 140, the method 100 also includes determining whether the geographic location associated with the transaction is geographically located within the geo-thresholds associated with the authorized user and/or whether the geographic location associated with the transaction is geographically proximate to the geographic location associated with the mobile device. The steps of determining whether the geographic location associated with the transaction is geographically located within the geo-thresholds associated with the authorized user and determining whether the geographic location associated with the transaction is geographically proximate to the geographic location associated with the mobile device may occur concurrently or in series. In one embodiment, if it is determined that the geographic location associated with the transaction is geographically located within the geo-thresholds associated with the authorized user, then the step of determining whether the geographic location associated with the transaction is geographically proximate to the geographic location associated with the mobile device may be skipped. In another embodiment, if it is determined that the geographic location associated with the transaction is geographically proximate to the geographic location associated with the mobile device, then the step of determining whether the geographic location associated with the transaction is geographically located within the geo-thresholds associated with the authorized user may be skipped.

In some exemplary embodiments, determining whether the geographic location associated with the transaction is geographically located within the geo-thresholds associated with the authorized user includes determining whether the geographic location associated with the transaction is geographically located within one or more geo-fences associated with the authorized user (e.g., one or more geo-fences specified by the authorized user).

In some exemplary embodiments, determining whether the geographic location associated with the transaction is geographically proximate to the geographic location associated with the mobile device comprises determining whether the mobile device is located within a predetermined distance from the location associated with the transaction. It will be appreciated that any approach to determining that the mobile device is located within a predetermined distance from the location associated with the transaction may be used. For example, a computer processor may compare the GPS coordinates associated with the mobile device with the GPS coordinates associated with the location of the transaction and calculate a distance. It will be appreciated that the predetermined distance may be any distance sufficient to establish an increased probability that the individual purporting to be an authorized user of the account involved in the transaction is the authorized user. In some example implementations, such as situations where a store is relatively large, such as a grocery store, and/or in situations where the point-of-transaction is relatively isolated from other businesses, the predetermined distance may be several dozen meters, or even a larger distance. In some situations, such as in densely populated marketplaces or apartment buildings, where many distinct spaces are placed within close proximity to each other, the predetermined distance may be less than a meter, or less than a few meters, to establish a sufficient probability that the user of the account information is located in the same space or apartment as the authorized user. The predetermined distance is somewhat influenced by the margin of error associated with the relating to the location of the point-of-transaction terminal. The more accurate the location information associated with the transaction, the tighter range that can be selected for the predetermined distance.

In other particular embodiments, determining whether the geographic location associated with the transaction is geographically proximate to the geographic location associated with the mobile device comprises determining whether the geographic location associated with the mobile device is geographically located within a geo-fence associated with the merchant.

Some example implementations contemplate one or more databases wherein location information is stored. For example, a database may store location information associated with the position of registers and/or other point-of-transaction devices within a store. In another example, a database may store information about the location of a store itself, such as whether a store is established as a stand-alone edifice or incorporated into a shopping center, shopping mall, open-air market, or other arrangement of points of sale. In some such examples, a predetermined distance associated with a particular point-of-transaction may be associated with and/or linked to location information stored in a database. For example, a store may select a particular predetermined distance based in part on the spacing of points of sale within the store. Other entities may select distances based on the size and/or orientation of a store. It will also be appreciated that a third party and/or the user of a mobile device may select a predetermined distance. For example, one user may choose to use a very short predetermined distance, while another user may select a larger distance. In some situations, a predetermined distance may take into account information about and/or associated with a point-of-transaction. For example, the type of goods or services offered by a particular entity may influence the calculation of a predetermined distance. In such a situation where a store specializes in high-end merchandise, such as a jewelry store or a boutique clothing store, the predetermined distance may be set to be relatively short. A store's history of crime and/or crime statistics for the area surrounding a store may also be taken into account in establishing a predetermined distance. For example, if an individual store or shopping center has experienced a number of occurrences where unauthorized transactions were made, the predetermined distance may be shortened to attempt to reduce the number of unauthorized transactions. It will be appreciated that these and other factors may be combined and/or considered in determining the predetermined distance. It will also be appreciated that a store, user, and/or third party may establish one or more predetermined distances for use with different transactions.

As shown in step 150, an alert is sent to the authorized user and/or to the merchant, if neither the geographic location associated with the transaction is geographically located within the geo-thresholds nor the geographic location associated with the transaction is geographically proximate to the geographic location associated with the mobile device. An alert may be sent, for example, via a telephone call, an SMS message, an email message, a social media message, and/or an instant message. By way of further example, an alert may be sent to the mobile device associated with the authorized user via an automated telephone call, an SMS message, and/or an email. In some exemplary embodiments, an alert may be sent to multiple devices associated with the authorized user.

In one embodiment, the alert is sent to the authorized user and/or to the merchant prior to determining whether to approve or disapprove the transaction. Any approach to approving or disapproving the transaction may be used. For example, a server associated with a financial institution may transmit an approval to a device at the point-of-transaction. In a particular embodiment, an alert sent to the merchant prior to determining whether to approve or disapprove the transaction includes a recommendation that the merchant engage in misappropriation prevention procedures (e.g., to prevent an unauthorized transaction). For example, the alert may recommend that the merchant check the photo identification of the individual engaging in the transaction to confirm that it is consistent with information associated with the authorized user. In another particular embodiment, a response to the alert may be received from the authorized user and/or from the merchant prior to determining whether to approve or disapprove the transaction. This response to the alert may include a recommendation that the transaction be approved or disapproved (e.g., denied). Accordingly, the transaction may be approved or disapproved based at least in part upon the response received from the authorized user and/or from the merchant.

In some embodiments, the method 100 includes, before sending an alert to an authorized user, determining whether the authorized user has consented (e.g., opted-in) to receiving alerts. If the authorized user has not consented to receiving alerts, then an alert is typically not sent to the authorized user. In such embodiments, a financial institution may provide incentives (e.g., account rewards, points, credits, miles, reduced account costs, coupons, and the like) to an authorized user of an account administered by the financial institution in exchange for the authorized user consenting to alerts.

In other embodiments, the method 100 includes, before sending an alert to a merchant, determining whether the merchant has consented (e.g., opted-in) to receiving alerts. If the merchant has not consented to receiving alerts, then an alert is typically not sent to the merchant. In such embodiments, a financial institution may provide incentives (e.g., reduced transaction costs) to a merchant in exchange for the merchant consenting to alerts.

In some embodiments, the method 100 includes determining whether to approve or disapprove the transaction based at least partially on whether the geographic location associated with the transaction is geographically located within the geo-thresholds and/or whether the geographic location associated with the transaction is geographically proximate to the geographic location associated with the mobile device. Any approach to approving or disapproving the transaction may be used. For example, in some exemplary embodiments, a server associated with a financial institution may transmit an approval to a device at the point-of-transaction.

In other exemplary embodiments, a device located at the point-of-transaction may hold or otherwise prevent the transaction from occurring absent an approval. A server associated with a financial institution may transmit a denial to a device at the point-of-transaction if neither the geographic location associated with the transaction is geographically located within the geo-thresholds nor the geographic location associated with the transaction is geographically proximate to the geographic location associated with the mobile device.

In some exemplary embodiments, information associated with a user's past transactions may be analyzed in determining whether to approve or deny a transaction. In some embodiments, the transaction location is a location where a previously approved transaction has occurred. If so, the transaction may be approved. In other embodiments, a time of day and/or time period associated with a transaction may be taken into account. For example, if a user typically purchases lunch at or around a particular time of day, a purchase made at a restaurant at or around that same time may be likely to be a legitimate transaction, and thus approved. In some such example implementations, and in other example implementations, the size and/or value of a transaction may be analyzed with reference to the size and/or value of previous transactions. For example, if a user routinely makes relatively small, but authorized purchases of music, film, and/or other media items at an electronics store or online, a purchase of expensive television, audio, and/or other high-end electronic equipment at the same store by someone purporting to be the user may be denied or referred for additional processing in the absence of other indicia of authorization, at least in part because the size and/or value of the transaction involving expensive equipment is dissimilar from the previously approved but much smaller and/or less valuable transactions. In some such example implementations and in other example implementations, patterns and/or cycles of previous transactions may be identified and analyzed when comparing a current transaction to information about a user's past transactions. For example, a user may exhibit a pattern of purchasing jewelry, toys, gifts, or other relatively costly items at particular times of year corresponding to time periods leading up to anniversaries, birthdays, holidays, and other recurring occasions. In another example, a user may exhibit a pattern of making a series of clothing and other purchases at the end of summer, corresponding to the period leading up to a child's return to school. In another example, a user may exhibit a history of periodically paying to have the oil changed in their car. In such example situations, an analysis of patterns and/or cycles of previous transactions may be incorporated into an analysis of a user's past transactions to identify transactions that are likely legitimate, even if the precise timing, size, and/or value of the transaction varies over time. It will be appreciated that any approach to analyzing and/or incorporating information associated with a user's past transactions may be use in example implementations of the systems and methods described herein.

Typically, an analysis of a user's previous transactions occurs in situations wherein neither the geographic location associated with the transaction is geographically located within the geo-thresholds nor the geographic location associated with the transaction is geographically proximate to the geographic location associated with the mobile device. That said, an analysis of a user's previous transactions may be employed in situations where the geographic location associated with the transaction is geographically located within the geo-thresholds and/or the geographic location associated with the transaction is geographically proximate to the geographic location associated with the mobile device. Some such example implementations contemplate situations where an unauthorized user has acquired a user's phone and account information, such as situations where a bag, briefcase, backpack, purse, or other item holding a user's wallet and phone are taken. Some such example implementations and other example implementations contemplate using information associated with previous, approved transactions as an additional layer of security. For example, an authentication device residing on a network may supplement a determination that the mobile device is within a predetermined distance from a location associated with a transaction with information about previous transactions that indicate that the transaction is appropriate before transmitting a final approval of the transaction and/or otherwise allowing the transaction to proceed.

Some example implementations contemplate one or more transaction value thresholds that may be considered as part of a determination to send an alert and/or accept and/or deny a transaction. For example, a predetermined threshold may be established such that transactions at and/or under a particular dollar value should be accepted, even if the mobile device is located outside of a predetermined distance. In another example implementation, a threshold may be established such that the mobile device must be located closer to the point-of-transaction for transactions valued at and/or over the threshold.

Some example implementations contemplate an ability for a user of a mobile device to override the denial or rejections of a transaction. In some such example implementations, prior to denying a transaction, a message is sent to the account user's mobile device and/or devices requesting that the user authenticate the transaction. It will be appreciated that any approach to transmitting a message to a user's mobile device may be used in such implementations, including but not limited to the use of an application, such as a mobile application or mobile app. It will be appreciated that any approach to authenticating a transaction from a mobile device may be used in such example implementations. For example, a user may enter an authorization code, such as a PIN number or some other predetermined password or code. In other examples, the user may select a link or other image presented on the display of the user's mobile device. In some such examples, and in other example implementations, the user of the mobile device may authenticate a transaction verbally, such as in response to an automated prompt or in conversation with a customer service representative. In some example situations where a user's mobile device is fitted with a digital camera, a user may authenticate the transaction visually by capturing and transmitting an image of the user or another image that denotes an authorization.

Referring now to FIG. 2, a system 200 for providing an unauthorized-transaction protection service is provided, in accordance with an aspect of the present invention. As illustrated in FIG. 2, the system 200 typically includes an alert apparatus 230 that is in communication with a transaction machine 220 and a mobile device 240 via a network 210. FIG. 2 also depicts an authorized user 202 (e.g., an account holder) and an account 208. The account 208 (e.g., a credit account, a deposit account, and the like) is associated with a banking account 209 (e.g., a credit account, a debit account, an online banking account, a mobile banking account, and the like). As shown, the authorized user 202 is associated with the mobile device 240 and the transaction machine 220. In accordance with some exemplary embodiments, the transaction machine 220 and the alert apparatus 230 are each maintained and/or controlled by the same financial institution. For example, in some embodiments, the user 202 is a customer of the financial institution, the alert apparatus 230 is embodied as an ATM transaction server maintained by the financial institution, and the transaction machine 220 is embodied as an ATM maintained by the financial institution. In such embodiments, the term “merchant” refers to the financial institution that maintains the transaction machine 220. However, in other embodiments, the transaction machine 220 and the alert apparatus 230 are maintained by separate entities. For example, in some embodiments, the transaction machine 220 is embodied as a POS and/or a point-of-transaction device maintained by a merchant, and the alert apparatus 230 is embodied as an authorization server maintained by a financial institution. In accordance with some embodiments, the mobile device 240 is associated with the user 202 and/or is carried, owned, and/or possessed by the user 202.

As shown in FIG. 2, the transaction machine 220, the alert apparatus 230, and the mobile device 240 are each operatively and selectively connected to the network 210, which may include one or more separate networks. The network 210 may include one or more payment networks (e.g., interbank networks, plastic card payment networks, and/or any wireline and/or wireless network over which payment information is sent), telephone networks (e.g., cellular networks, CDMA networks, any wireline and/or wireless network over which communications to telephones and/or mobile phones are sent, and the like), local area networks (LANs), wide area networks (WANs), global area networks (GANs) (e.g., the Internet, and the like), and/or one or more other telecommunications networks. For example, in some embodiments, the network 210 includes a telephone network (e.g., for communicating with the mobile device 240) and a payment network (e.g., for communicating with the transaction machine 220). It will also be appreciated that the network 210 may be secure and/or unsecure and may also include wireless and/or wireline technology.

The transaction machine 220 may include any computerized apparatus that can be configured to perform any one or more of the functions of the transaction machine 220 described and/or contemplated herein. It will also be understood that the transaction machine 220 can include and/or be embodied as, any transaction machine described and/or contemplated herein. It will further be understood that the transaction machine 220 can initiate, perform, complete, and/or otherwise facilitate any transaction described and/or contemplated herein as being initiated, performed, and/or otherwise facilitated by a transaction machine. For example, in some embodiments, the transaction machine 220 includes and/or is embodied as an ATM, a POS device, a self-checkout machine, a vending machine, a ticketing kiosk, a personal computer, a gaming device, a mobile phone, and/or the like. As another example, in some embodiments, the transaction machine 220 is configured to initiate, perform, complete, and/or otherwise facilitate one or more financial and/or non-financial transactions, including, for example, purchasing, renting, selling, and/or leasing goods and/or services (e.g., groceries, stamps, tickets, gift certificates, DVDs, and the like); withdrawing cash; making deposits (e.g., cash, checks, and the like); making payments (e.g., paying telephone bills, sending remittances, and the like); accessing the Internet; and/or the like.

In some embodiments, the transaction machine 220 (and/or one or more other portions of the system 200) requires its users to authenticate themselves to the transaction machine 220 before the transaction machine 220 will initiate, perform, complete, and/or facilitate a transaction. For example, in some embodiments, the transaction machine 220 (and/or the transaction application 227) is configured to authenticate a transaction machine user based at least partially on an ATM/debit/credit card, loyalty/rewards/club card, smart card, token (e.g., a USB token), username/password, personal identification number (PIN), biometric information, and/or one or more other credentials that the user presents to the transaction machine 220. Additionally or alternatively, in some embodiments, the transaction machine 220 is configured to authenticate a user by using one-, two-, or multi-factor authentication. For example, in some embodiments, the transaction machine 220 requires two-factor authentication, such that the authorized user 202 must provide a valid debit card and enter the correct PIN associated with the debit card in order to partially authenticate the user 202 to the transaction machine 220.

As illustrated in FIG. 2, the transaction machine 220 typically includes a communication interface 222, a processor 224, a memory 226 having a transaction application 227 stored therein, and a user interface 229. In such embodiments, the processor 224 is operatively and selectively connected to the communication interface 222, the user interface 229, and the memory 226.

Each communication interface described herein, including the communication interface 222, generally includes hardware, and, in some instances, software, that enables a portion of the system 200, such as the transaction machine 220, to send, receive, and/or otherwise communicate information to and/or from the communication interface of one or more other portions of the system 200. For example, the communication interface 222 of the transaction machine 220 may include a modem, network interface controller (NIC), NFC interface, network adapter, network interface card, and/or some other electronic communication device that operatively connects the transaction machine 220 to another portion of the system 200, such as the alert apparatus 230.

Each processor described herein, including the processor 224, generally includes circuitry for implementing the audio, visual, and/or logic functions of that portion of the system 200. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the transaction application 227 of the memory 226 of the transaction machine 220.

Each memory device described herein, including the memory 226 for storing the transaction application 227 and other information, may include any computer-readable medium. For example, the memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus.

As shown in FIG. 2, the memory 226 includes the transaction application 227. It will be understood that the transaction application 227 can be operable (e.g., usable, executable, and the like) to initiate, perform, complete, and/or facilitate one or more portions of any embodiment described and/or contemplated herein, such as, for example, one or more portions of the method 100 described herein. For example, in some embodiments, the transaction application 227 is operable to receive transaction information associated with a transaction. As another example, in some embodiments, the transaction application 227 is operable to determine, via the processor 224, that the mobile device 240 associated with the user 202 is located within or without a predetermined distance from a location associated with the transaction. As still another example, in some embodiments, the transaction application 227 is operable to receive, via the communication interface 222, information indicating that a transaction has been approved or disapproved. As another example, in some embodiments, the transaction application 227 is operable to approve or disapprove a transaction (e.g., based at least partially on a determination that the mobile device 240 associated with the user 202 is located within or outside a predetermined distance from a location associated with the transaction and/or based upon a determination that the location associated with the transaction is within geo-thresholds associated with the authorized user 202). In some embodiments, the transaction application 227 is operable to complete one or more transactions at the transaction machine 220 (e.g., complete a purchase transaction, dispense cash, accept a check for deposit, and the like).

In some embodiments, where the transaction machine 220 includes and/or is embodied as an ATM, the transaction application 227 is configured to execute on the ATM in order to initiate, perform, complete, and/or facilitate, for example, one or more cash withdrawals, deposits, and/or the like. In other embodiments, where the transaction machine 220 includes and/or is embodied as a point-of-transaction device, the transaction application 227 is configured to execute on the point-of-transaction device in order to initiate, perform, complete, and/or facilitate, for example, one or more debit card and/or credit card transactions. In still other embodiments, where the transaction machine 220 includes and/or is embodied as a personal computer, the transaction application 227 is configured to execute on the personal computer, and, in some embodiments, the transaction application 227 is embodied as a web browser (e.g., for navigating the Internet) that is operable to initiate, perform, complete, and/or otherwise facilitate one or more financial and/or non-financial transactions.

In some embodiments, the transaction application 227 is operable to enable the user 202 and/or transaction machine 220 to communicate with one or more other portions of the system 200, and/or vice versa. In some embodiments, the transaction application 227 is additionally or alternatively operable to initiate, perform, complete, and/or otherwise facilitate one or more financial and/or non-financial transactions. In some embodiments, the transaction application 227 includes one or more computer-executable program code portions for causing and/or instructing the processor 224 to perform one or more of the functions of the transaction application 227 and/or transaction machine 220 described and/or contemplated herein. In some embodiments, the transaction application 227 includes and/or uses one or more network and/or system communication protocols.

As shown in FIG. 2, the transaction machine 220 also includes the user interface 229. It will be understood that the user interface 229 (and any other user interface described and/or contemplated herein) can include and/or be embodied as one or more user interfaces. It will also be understood that, in some embodiments, the user interface 229 includes one or more user output devices for presenting information and/or one or more items to the transaction machine user (e.g., the user 202), such as one or more displays, speakers, receipt printers, dispensers (e.g., cash dispensers, ticket dispensers, merchandise dispensers, and the like), and/or the like. In some embodiments, the user interface 229 additionally or alternatively includes one or more user input devices, such as, for example, one or more buttons, keys, dials, levers, directional pads, joysticks, keyboards, mice, accelerometers, controllers, microphones, touchpads, touchscreens, haptic interfaces, styluses, scanners, biometric readers, motion detectors, cameras, card readers (e.g., for reading the magnetic strip on magnetic cards such as ATM, debit, credit, and/or bank cards, and the like), deposit mechanisms (e.g., for depositing checks and/or cash, and the like), and/or the like for receiving information from one or more items and/or from the transaction machine user (e.g., the user 202). In some embodiments, the user interface 229 and/or the transaction machine 220 includes one or more vaults, security sensors, locks, and/or anything else typically included in and/or near the transaction machine.

In some embodiments, a transaction may refer to an event and/or action or group of actions facilitated or performed by a user's device, such as a user's mobile device. Such a device may be referred to herein as a transaction machine, such as transaction machine 220, and/or as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point-of-transaction terminal, whereas in other embodiments, the point-of-transaction device refers to the merchant's point-of-transaction terminal configured to communicate with a user's mobile device, and in yet other embodiments, the point-of-transaction device refers to both the user's mobile device and the merchant's point-of-transaction terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, and the like), a personal identification number (PIN) payment device, a contactless payment device (e.g., a key fob), a radio frequency identification device (RFID) and the like, a computer, (e.g., a personal computer, tablet computer, desktop computer, server, laptop, and the like), a mobile device (e.g., a smartphone, laptop computer, tablet computer, cellular phone, personal digital assistant (PDA) device, MP3 device, personal GPS device, and the like), a merchant terminal, a self-service machine (e.g., vending machine, self-checkout machine, and the like), a public and/or business kiosk (e.g., an Internet kiosk, ticketing kiosk, bill pay kiosk, and the like), a gaming device, and/or various combinations of the foregoing.

In some embodiments, a point-of-transaction device is operated in a public place (e.g., on a street corner, at the doorstep of a private residence, in an open market, at a public rest stop, and the like). In other embodiments, the point-of-transaction device is additionally or alternatively operated in a place of business (e.g., in a retail store, post office, banking center, grocery store, factory floor, and the like). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, and the like). In yet other embodiments, the point-of-transaction device is owned by the financial institution offering the point-of-transaction device providing functionality in accordance with embodiments of the invention described herein.

FIG. 2 also illustrates an alert apparatus 230, in accordance with an embodiment of the present invention. The alert apparatus 230 may include any computerized apparatus that can be configured to perform any one or more of the functions of the alert apparatus 230 described and/or contemplated herein. It will also be understood that the alert apparatus 230 can include and/or be embodied as any alert apparatus described and/or contemplated herein. It will further be understood that the alert apparatus can initiate, perform, complete, and/or otherwise facilitate user and/or merchant alerts as described and/or contemplated herein. In some embodiments the alert apparatus 230 can initiate, perform, complete, and/or otherwise facilitate any transaction described and/or contemplated herein as being initiated, performed, and/or otherwise facilitated by an alert apparatus. In some embodiments, the alert apparatus 230 includes and/or is embodied as one or more servers, engines, mainframes, personal computers, ATMs, network devices, front end systems, back end systems, and/or the like. As depicted in FIG. 2, the alert apparatus 230 typically includes a communication interface 232, a processor 234, and a memory 236, which includes an alert application 237 and an alert datastore 238 stored therein. As depicted in FIG. 2, the communication interface 232 is typically operatively and selectively connected to the processor 234, which is operatively and selectively connected to the memory 236.

The alert application 237 can be operable (e.g., usable, executable, and the like) to initiate, perform, complete, and/or facilitate any one or more portions of the method 100 described herein. In typical embodiments, the alert application 237 is operable to establish geo-thresholds associated with the authorized user 202 of the account 208. The alert application 237 is typically operable to receive transaction information associated with a transaction associated with a merchant, such as a location associated with a transaction and location information associated with the mobile device 240 that is associated with the authorized user 202. Furthermore, the alert application 237 is typically operable to determine (e.g., via the processor 234) if the mobile device 240 associated with the user 202 is located proximate to the location associated with the transaction. The alert application 237 is also typically operable to determine (e.g., via the processor 234) if the location associated with the transaction is within the geo-thresholds associated with the authorized user 202 of the account 208. In such typical embodiments, the alert application 237 is operable to send an alert to the authorized user 202 (e.g., to a device associated with the user, such as the mobile device 240) and/or to the merchant associated with the transaction (e.g., to a device associated with the merchant, such as the transaction machine 220) if neither the mobile device 240 associated with the user 202 is located proximate to the location associated with the transaction nor the location associated with the transaction is within the geo-thresholds associated with the authorized user 202 of the account 208. In some embodiments, the alert application 237 is operable to approve or disapprove the transaction, based at least partially on a determination of whether the mobile device 240 associated with the user 202 is located proximate to the location associated with the transaction and/or whether the location associated with the transaction is within the geo-thresholds associated with the authorized user 202 of the account 208. In some embodiments, the alert application 237 may be operable to complete one or more authorizations at the alert apparatus 230 (e.g., approve a cash withdrawal, disapprove a credit or debit to an account, and/or refer the transaction for further investigation). In this regard, the alert application 237 may be operable to authorize a transaction and/or complete a transaction.

In some embodiments, the alert application 237 is operable to enable the alert apparatus 230 to communicate with one or more other portions of the system 200, such as, for example, the alert datastore 238, the mobile device 240, and/or the transaction machine 220, and/or vice versa. In addition, in some embodiments, the alert application 237 is operable to initiate, perform, complete, and/or otherwise facilitate one or more financial and/or non-financial transactions. In some embodiments, the alert application 237 includes one or more computer-executable program code portions for causing and/or instructing the processor 234 to perform one or more of the functions of the alert application 237 and/or the alert apparatus 230 that are described and/or contemplated herein. In some embodiments, the alert application 237 includes and/or uses one or more network and/or system communication protocols.

In addition to the alert application 237, the memory 236 also includes the alert datastore 238. It will be understood that the alert datastore 238 can be configured to store any type and/or amount of information. For example, in some embodiments, the alert datastore 238 includes information associated with one or more transaction machines, transaction machine users, transactions, transaction patterns and/or habits, financial accounts, electronic banking accounts, addresses associated with accounts, mobile devices, authorization requests, merchants, account holders, authorized users, geo-thresholds, and/or the like. In some embodiments, the alert datastore 238 may also store any information related to providing an unauthorized-transaction protection system. In some embodiments, the alert datastore 238 additionally or alternatively stores information associated with electronic banking and/or electronic banking accounts.

In accordance with some embodiments, the alert datastore 238 may include any one or more storage devices, including, but not limited to, datastores, databases, and/or any of the other storage devices typically associated with a computer system. It will also be understood that the alert datastore 238 may store information in any known way, such as, for example, by using one or more computer codes and/or languages, alphanumeric character strings, data sets, figures, tables, charts, links, documents, and/or the like. Further, in some embodiments, the alert datastore 238 includes information associated with one or more applications, such as, for example, the alert application 237 and/or the transaction application 227. In some embodiments, the alert datastore 238 provides a real-time or near real-time representation of the information stored therein, so that, for example, when the processor 234 accesses the alert datastore 238, the information stored therein is current or nearly current. Although not shown, in some embodiments, the transaction machine 220 includes a transaction datastore that is configured to store any information associated with the transaction machine 220, the transaction application 227, and/or the like. It will be understood that the transaction datastore can store information in any known way, can include information associated with anything shown in FIG. 2, and/or can be configured similar to the alert datastore 238.

Referring now to FIG. 3, a block diagram is provided that illustrates the mobile device 240 of FIG. 2 in more detail, in accordance with an embodiment of the invention. In some embodiments, the mobile device 240 is a mobile phone, but in other embodiments, the mobile device 240 can include and/or be embodied as any other mobile device described and/or contemplated herein. The mobile device 240 typically includes a processor 244 operatively connected to such devices as a memory 246, a user interface 249 (e.g., user output devices 249A and user input devices 249B), a communication interface 242, a power source 245, a clock or other timer 243, a camera 241, and a positioning system device 290.

The processor 244 may include the functionality to encode and interleave messages and data prior to modulation and transmission. The processor 244 can additionally include an internal data modem. Further, the processor 244 may include functionality to operate one or more software programs, which may be stored in the memory 246. For example, the processor 244 may be capable of operating a connectivity program, such as a web browser application 248. The web browser application 248 may then allow the mobile device 240 to transmit and receive web content, such as, for example, location-based content and/or other web page content, according to a Wireless Application Protocol (WAP), Hypertext Transfer Protocol (HTTP), and/or the like.

The processor 244 is typically configured to use the communication interface 242 to communicate with one or more other devices on the network 210. In this regard, the communication interface 242 typically includes an antenna 276 operatively coupled to a transmitter 274 and a receiver 272 (together a “transceiver”). The processor 244 is typically configured to provide signals to and receive signals from the transmitter 274 and receiver 272, respectively. The signals may include signaling information in accordance with the air interface standard of the applicable cellular system of the wireless telephone network 210. In this regard, the mobile device 240 may be configured to operate with one or more air interface standards, communication protocols, modulation types, and access types. By way of illustration, the mobile device 240 may be configured to operate in accordance with any of a number of first, second, third, and/or fourth-generation communication protocols and/or the like. For example, the mobile device 240 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 240 may also be configured to operate in accordance with non-cellular communication mechanisms, such as via a wireless local area network (WLAN) or other communication/data networks.

The communication interface 242 may also include a near field communication (NFC) interface 270. As used herein, the phrase “NFC interface” generally refers to hardware and/or software that is configured to contactlessly and/or wirelessly send and/or receive information over relatively short ranges (e.g., within four inches, within three feet, within fifteen feet, and the like). The NFC interface 270 may include a smart card, key card, proximity card, Bluetooth® device, radio frequency identification (RFID) tag and/or reader, transmitter, receiver, and/or the like. In some embodiments, the NFC interface 270 communicates information via radio, infrared (IR), and/or optical transmissions. In some embodiments, the NFC interface 270 is configured to operate as an NFC transmitter and/or as an NFC receiver (e.g., an NFC reader). In some embodiments, the NFC interface 270 enables the mobile device 240 to operate as a mobile wallet. Also, it will be understood that the NFC interface 270 may be embedded, built, carried, and/or otherwise supported in and/or on the mobile device 240. In some embodiments, the NFC interface 270 is not supported in and/or on the mobile device 240, but the NFC interface 270 is otherwise operatively connected to the mobile device 240 (e.g., where the NFC interface 270 is a peripheral device plugged into the mobile device 240). Other apparatuses having NFC interfaces mentioned herein may be configured similarly.

In some embodiments, the NFC interface 270 of the mobile device 240 is configured to contactlessly and/or wirelessly communicate information to and/or from a corresponding NFC interface of another apparatus (e.g., the transaction machine 220). For example, in some embodiments the mobile device 240 is a mobile phone, the NFC interface 270 is a smart card having account information stored therein, and the transaction machine 220 is a POS and/or point-of-transaction device having an NFC reader operatively connected thereto. In such embodiments, when the mobile phone and/or smart card is brought within a relatively short range of the NFC reader, the smart card is configured to wirelessly and/or contactlessly send the account information to the NFC reader in order to, for example, initiate, perform, complete, and/or otherwise facilitate a transaction.

In addition to the NFC interface 270, the mobile device 240 can have a user interface 249 that is, like other user interfaces described herein, made up of one or more user output devices 249A and/or user input devices 249B. The user output devices 249A typically include a display 280 (e.g., a liquid crystal display and/or the like) and a speaker 182 and/or other audio device, which are operatively coupled to the processor 244. The user input devices 249B, which allow the mobile device 240 to receive data from a user such as the user 202, may include any of a number of devices allowing the mobile device 240 to receive data from a user, such as a keypad, keyboard, touch-screen, touchpad, microphone, mouse, joystick, other pointer device, button, soft key, and/or other input device(s). The user interface 249 may also include a camera 241, such as a digital camera.

In typical embodiments, the mobile device 240 also includes a positioning system device 290 that can be used to determine the location of the mobile device 240. For example, the positioning system device 290 may include a GPS transceiver. In some embodiments, the positioning system device 290 is at least partially made up of the antenna 276, the transmitter 274, and the receiver 272 described above. For example, in one embodiment triangulation of cellular signals may be used to identify the approximate location of the mobile device 240. In other embodiments, the positioning system device 290 includes a proximity sensor and/or transmitter, such as an RFID tag, that can sense or be sensed by devices known to be located proximate a merchant and/or other location to determine that the mobile device 240 is located proximate these known devices.

The mobile device 240 further typically includes a power source 245, such as a battery, for powering various circuits and other devices that are used to operate the mobile device 240. Embodiments of the mobile device 240 may also include a clock or other timer 243 configured to determine and, in some cases, communicate actual or relative time to the processor 244 or one or more other devices.

The mobile device 240 also typically includes a memory 246 operatively connected to the processor 244. As used herein, memory includes any computer readable medium (as defined herein) configured to store data, code, and/or other information. The memory 246 may include volatile memory, such as volatile Random Access Memory (RAM) including a cache area for the temporary storage of data. The memory 246 may also include non-volatile memory, which can be embedded and/or may be removable. The non-volatile memory can additionally or alternatively include an electrically erasable programmable read-only memory (EEPROM), flash memory or the like.

The memory 246 can store any of a number of applications which may include computer-executable instructions/code executed by the processor 244 to implement the functions of the mobile device 240 described herein. For example, the memory 246 may include such applications as a web browser application 248 and/or a mobile banking application 247. It will be understood that the web browser application 248 and/or the mobile banking application 247 can be, individually or collectively, operable (e.g., usable, executable, and the like) to initiate, perform, complete, and/or facilitate any one or more portions of the method 100 described herein.

The embodiments illustrated in FIGS. 2 and 3 are exemplary and other embodiments may vary. For example, in some embodiments, some or all of the portions of the system 200 are combined into a single portion. Specifically, in some embodiments, the transaction machine 220 and the alert apparatus 230 are combined into a single transaction and alert apparatus that is configured to perform all of the same functions of those separate portions as described and/or contemplated herein. Likewise, in some embodiments, some or all of the portions of the system 200 are separated into two or more distinct portions. In addition, the various portions of the system 200 may be maintained by the same or separate parties.

The system 200 and/or one or more portions of the system 200 may include and/or implement any embodiment of the present invention described and/or contemplated herein. For example, in some embodiments, the system 200 (and/or one or more portions of the system 200) is configured to implement any one or more embodiments of the method 100 described and/or contemplated herein in connection with FIG. 1 and/or any method and/or other sequence described herein.

It will be appreciated that while many of the example embodiments described herein refer to or contemplate a mobile device in the form of a mobile phone, any mobile device associated with a user and having a recognizable position may be used in example implementations of the systems and processes described herein. For example, a user's vehicle may be capable of providing GPS data. In such an example implementation, a determination that the user's vehicle is in a parking lot associated with a store or other point-of-transaction may constitute a determination that the mobile device is within a predetermined distance from a location associated with a transaction. In other example implementations, a mobile device may take the form of a personal identification number (PIN) payment device, a contactless payment device (e.g., a key fob), a radio frequency identification device (RFID) and the like, a computer, (e.g., a personal computer, tablet computer, desktop computer, server, laptop, and the like), a mobile device (e.g., a smartphone, cellular phone, personal digital assistant (PDA) device, MP3 device, personal GPS device, and the like), or any other device that a user may tend to keep on or near their person when engaging in a transaction.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for protecting against an unauthorized transaction, comprising:
a computing device comprising a memory and at least one processor; and
an unauthorized-transaction protection application stored in the memory, executable by the processor, and configured to:
establish geo-thresholds associated with an authorized user;
receive a set of information associated with a transaction associated with the authorized user and with a merchant, wherein the set of information associated with the transaction comprises an identification of a geographic location associated with the transaction;
receive a set of geographic location information associated with a mobile device, wherein the mobile device is associated with the authorized user associated with the transaction;
determine whether the geographic location associated with the transaction is geographically located within the geo-thresholds and/or whether the geographic location associated with the transaction is geographically proximate to the geographic location associated with the mobile device; and
if neither the geographic location associated with the transaction is geographically located within the geo-thresholds nor the geographic location associated with the transaction is geographically proximate to the geographic location associated with the mobile device, send an alert to the authorized user and/or to the merchant.

2. The system according to claim 1, wherein the unauthorized-transaction protection application is configured to determine whether to approve or disapprove the transaction based at least partially on whether the geographic location associated with the transaction is geographically located within the geo-thresholds and/or whether the geographic location associated with the transaction is geographically proximate to the geographic location associated with the mobile device.

3. The system according to claim 1, wherein the unauthorized-transaction protection application is configured to approve or disapprove the transaction, and wherein sending an alert to the authorized user and/or to the merchant comprises sending an alert to the merchant prior to approving or disapproving the transaction, the alert including a recommendation that the merchant engage in misappropriation prevention procedures.

4. The system according to claim 1, wherein:
establishing geo-thresholds associated with the authorized user comprises establishing one or more geo-fences associated with the authorized user; and
determining whether the geographic location associated with the transaction is geographically located within the geo-thresholds comprises determining whether the geographic location associated with the transaction is geographically located within at least one of the geo-fences associated with the authorized user.

5. The system according to claim 1, wherein the geo-thresholds associated with the authorized user comprise one or more geo-fences specified by the authorized user.

6. The system according to claim 1, wherein determining whether the geographic location associated with the transaction is geographically proximate to the geographic location associated with the mobile device comprises determining whether the geographic location associated with the transaction is geographically located within a predetermined distance from the geographic location associated with the mobile device.

7. The system according to claim 1, wherein determining whether the geographic location associated with the transaction is geographically proximate to the geographic location associated with the mobile device comprises determining whether the geographic location associated with the mobile device is geographically located within a geo-fence associated with the merchant.

8. The system according to claim 1, wherein sending an alert to the authorized user and/or to the merchant comprises sending an alert to the mobile device associated with the authorized user.

9. A method for protecting against an unauthorized transaction, comprising:
establishing geo-thresholds associated with an authorized user;
receiving a set of information associated with a transaction associated with the authorized user and with a merchant, wherein the set of information associated with the transaction comprises an identification of a geographic location associated with the transaction;
receiving a set of geographic location information associated with a mobile device, wherein the mobile device is associated with the authorized user associated with the transaction;
determining, via a computer processor, whether the geographic location associated with the transaction is geographically located within the geo-thresholds and/or whether the geographic location associated with the transaction is geographically proximate to the geographic location associated with the mobile device; and
if neither the geographic location associated with the transaction is geographically located within the geo-thresholds nor the geographic location associated with the transaction is geographically proximate to the geographic location associated with the mobile device, sending an alert to the authorized user and/or to the merchant.

10. The method according to claim 9, comprising determining, via a computer processor, whether to approve or disapprove the transaction based at least partially on whether the geographic location associated with the transaction is geographically located within the geo-thresholds and/or whether the geographic location associated with the transaction is geographically proximate to the geographic location associated with the mobile device.

11. The method according to claim 9, comprising approving or disapproving the transaction, wherein sending an alert to the authorized user and/or to the merchant comprises sending an alert to the merchant prior to approving or disapproving the transaction, the alert including a recommendation that the merchant engage in misappropriation prevention procedures.

12. The method according to claim 9, wherein:
establishing geo-thresholds associated with the authorized user comprises establishing one or more geo-fences associated with the authorized user; and
determining whether the geographic location associated with the transaction is geographically located within the geo-thresholds comprises determining whether the geographic location associated with the transaction is geographically located within at least one of the geo-fences associated with the authorized user.

13. The method according to claim 12, wherein the geo-thresholds associated with the authorized user comprise one or more geo-fences specified by the authorized user.

14. The method according to claim 9, wherein determining whether the geographic location associated with the transaction is geographically proximate to the geographic location associated with the mobile device comprises determining whether the geographic location associated with the transaction is geographically located within a predetermined distance from the geographic location associated with the mobile device.

15. The method according to claim 9, wherein determining whether the geographic location associated with the transaction is geographically proximate to the geographic location associated with the mobile device comprises determining whether the geographic location associated with the mobile device is geographically located within a geo-fence associated with the merchant.

16. The method according to claim 9, wherein sending an alert to the authorized user and/or to the merchant comprises sending an alert to the mobile device associated with the authorized user.

17. A computer program product, comprising:
a non-transitory computer-readable storage medium comprising codes for causing a computer processor to be configured to:
establish geo-thresholds associated with an authorized user;
receive a set of information associated with a transaction associated with the authorized user and with a merchant, wherein the set of information associated with the transaction comprises an identification of a geographic location associated with the transaction;
receive a set of geographic location information associated with a mobile device, wherein the mobile device is associated with the authorized user associated with the transaction;
determine whether the geographic location associated with the transaction is geographically located within the geo-thresholds and/or whether the geographic location associated with the transaction is geographically proximate to the geographic location associated with the mobile device; and
if neither the geographic location associated with the transaction is geographically located within the geo-thresholds nor the geographic location associated with the transaction is geographically proximate to the geographic location associated with the mobile device, send an alert to the authorized user and/or to the merchant.

18. The computer program product according to claim 17, wherein the non-transitory computer-readable storage medium comprises codes for causing the computer processor to be configured to determine whether to approve or disapprove the transaction based at least partially on whether the geographic location associated with the transaction is geographically located within the geo-thresholds and/or whether the geographic location associated with the transaction is geographically proximate to the geographic location associated with the mobile device.

19. The computer program product according to claim 17, wherein the non-transitory computer-readable storage medium comprises codes for causing the computer processor to be configured to approve or disapprove the transaction, and wherein sending an alert to the authorized user and/or to the merchant comprises sending an alert to the merchant prior to approving or disapproving the transaction, the alert including a recommendation that the merchant engage in misappropriation prevention procedures.

20. The computer program product according to claim 17, wherein:
establishing geo-thresholds associated with the authorized user comprises establishing one or more geo-fences associated with the authorized user; and
determining whether the geographic location associated with the transaction is geographically located within the geo-thresholds comprises determining whether the geographic location associated with the transaction is geographically located within at least one of the geo-fences associated with the authorized user.

21. The computer program product according to claim 20, wherein the geo-thresholds associated with the authorized user comprise one or more geo-fences specified by the authorized user.

22. The computer program product according to claim 17, wherein determining whether the geographic location associated with the transaction is geographically proximate to the geographic location associated with the mobile device comprises determining whether the geographic location associated with the transaction is geographically located within a predetermined distance from the geographic location associated with the mobile device.

23. The computer program product according to claim 17, wherein determining whether the geographic location associated with the transaction is geographically proximate to the geographic location associated with the mobile device comprises determining whether the geographic location associated with the mobile device is geographically located within a geo-fence associated with the merchant.

24. The computer program product according to claim 17, wherein sending an alert to the authorized user and/or to the merchant comprises sending an alert to the mobile device associated with the authorized user.
